(19) United States
(12) Patent Application Publication
(10) Pub. No.: US 2018/0105941 A1
(43) Pub. Date: Apr. 19, 2018

(54) PLANAR DISSOLVED OXYGEN SENSING ELECTRODE AND MANUFACTURING METHOD THEREOF

(71) Applicant: Akubic (Cayman) Limited, Grand Cayman (KY)

(72) Inventors: KUAN-JUNG CHEN, Taipei City (TW); SHIH-HAO KO, Taipei City (TW); CHIH-YUNG TSENG, Taipei City (TW); HSIAO-HAN YU, Taipei City (TW)

(21) Appl. No.: 15/642,030

(22) Filed: Jul. 5, 2017

Related U.S. Application Data
(60) Provisional application No. 62/408,924, filed on Oct. 17, 2016.

(30) Foreign Application Priority Data
May 25, 2017 (CN) 201710411401.X

(51) Int. Cl. C25B 3/10; H01M 4/62; H01M 4/54

(52) U.S. Cl. CPC C25B 3/10; H01M 4/48; H01M 4/54; H01M 4/622

(57) ABSTRACT

A planar dissolved oxygen sensing electrode for water quality monitoring and a manufacturing method thereof are provided. The sensing electrode includes an insulating base plate, an electric-conductive layer, an oxygen sensing layer, a reference sensing layer, and an electrolyte layer. The electric-conductive layer is disposed on the planar surface of the insulating base plate. The electric-conductive layer includes a first conductive part, a second conductive part, a first reaction zone and a second reaction zone. The first conductive part and the second conductive part are connected to the first reaction zone and the second reaction zone, respectively. The oxygen sensing layer disposed on the first reaction zone includes plural catalyst particles dispersed in the polymer matrix. The reference sensing layer is disposed on the second reaction zone. The electrolyte layer is disposed on the oxygen sensing layer and the reference sensing layer.

### CROSS-REFERENCE TO RELATED APPLICATION

This application claims the benefit of U.S. Provisional Application No. 62/408,924 filed on Oct. 17, 2016, and entitled “ELECTROCHEMICAL SENSING DEVICE FOR WATER QUALITY MONITORING PLANAR SENSING ELECTRODES AND FABRICATING METHOD THEREOF”. This application claims priority to China Patent Application No. 201710411401.X filed on May 25, 2017. The entire contents of the above-mentioned applications are incorporated herein by reference for all purposes.

### FIELD OF THE INVENTION

The present invention relates to a sensing electrode for water quality monitoring, and more particularly to a planar dissolved oxygen sensing electrode and a manufacturing method thereof.

### BACKGROUND OF THE INVENTION

For a conventional water quality monitoring, it takes a lot of time and manpower to sample and analyze, and the problems of the ineffective wastewater treatment or the abnormal quality of the treated water cannot be reported efficiently and immediately, so that the quality of the river's receiving water is affected by the discharged wastewater. In order to meet the actual demand, the water quality monitoring device should be able to analyze the real-time water quality to effectively monitor the effectiveness of the water treatment and the changing conditions of the water quality, thereby improving the related operating procedures of handling process. On the other hand, while the requirement for recycling water is increased, the requirement of the water quality monitoring device with the on-site monitoring ability is also increased significantly.

However, the conventional water quality monitoring device is provided with a glass electrode as its ion sensing electrode. Although the glass electrode can be used to measure the ion concentration in the water stably, it has a complex structure, costs a lot, and is not conducive to miniaturization. In addition, due to the structural limitations of the glass electrode and the reference electrode in the water quality monitoring device, the sensing sensitivity thereof cannot be improved. The precious metals, such as platinum, gold, and silver are used to form the block-like structure in the conventional polarographic dissolved oxygen sensing electrode. Since a large amount of the precious metals is used, the cost of the conventional sensing electrode is relatively expensive and the sensitivity thereof is poor.

Therefore, there is a need of providing a planar dissolved oxygen sensing electrode and a manufacturing method thereof for water quality monitoring to meet the above requirements and solve the above problems.

### SUMMARY OF THE INVENTION

An object of the present invention is to provide a planar dissolved oxygen sensing electrode and a manufacturing method thereof. The sensing sensitivity of the dissolved oxygen sensing electrode is improved by utilizing the planar structure and the composites of the catalyst particles and the polymer matrix. The oxygen sensing layer constructed by the composites of the catalyst particles and the polymer matrix can enhance the sensitivity sensed by the conventional polarographic dissolved oxygen measurement. The planar sensing layers facilitates to reduce the entire volume of the sensing electrode and reduce the cost of the manufacturing raw materials. Consequently, the planar dissolved oxygen sensing electrode with high selectivity and high sensitivity can be applied in the fields of the medicine, the biochemistry, the chemistry, the agriculture, the environmental and others. For example, it can be applied to monitor the variation of the dissolved oxygen concentrations during the planting process of hydroponic plants, the dissolved oxygen amount in the blood, the dissolved oxygen amount in the eye, the dissolved oxygen amount for the water quality of the aquaculture, or the specific biological indicators (e.g. glucose) by means of combining the specific enzymes.

Another object of the present invention is to provide a planar dissolved oxygen sensing electrode and a manufacturing method thereof. The structure is compact, the manufacturing process is simplified, and the cost is reduced, so as to facilitate to achieve the purpose of providing disposable sensing electrodes.

In accordance with an aspect of the present invention, a planar dissolved oxygen sensing electrode is provided. The planar dissolved oxygen sensing electrode includes an insulating base plate, an electric-conductive layer, an oxygen sensing layer, a reference sensing layer and an electrolyte layer. The insulating base plate includes at least one planar surface. The electric-conductive layer is disposed on the planar surface of the insulating base plate. The electric-conductive layer includes a first conductive part, a second conductive part, a first reaction zone and a second reaction zone. The first conductive part and the second conductive part are insulated and apart from each other and connected to the first reaction zone and the second reaction zone, respectively. The oxygen sensing layer is disposed on the first reaction zone. The oxygen sensing layer includes plural catalyst particles and a polymer matrix and the plural catalyst particles are dispersed in the polymer matrix. The reference sensing layer is disposed on the second reaction zone. The electrolyte layer is disposed on and covers the oxygen sensing layer and the reference sensing layer.

In accordance with another aspect of the present invention, a manufacturing method of a planar dissolved oxygen sensing electrode is provided. The manufacturing method includes steps of: (a) providing an insulating base plate including at least one planar surface, and forming an electric-conductive layer on the at least one planar surface of the insulating base plate, wherein the electric-conductive layer includes a first conductive part, a second conductive part, a first reaction zone and a second reaction zone, and the first conductive part and the second conductive part are insulated and apart from each other and connected to the first reaction zone and the second reaction zone, respectively; (b) forming an oxygen sensing layer on the first reaction zone and a reference sensing layer on the second reaction zone, respectively, wherein the oxygen sensing layer includes plural catalyst particles and a polymer matrix and the plural catalyst particles are dispersed in the polymer matrix; and (c) forming an electrolyte layer to cover over the oxygen sensing layer and the reference sensing layer.

The above contents of the present invention will become more readily apparent to those ordinarily skilled in the art after reviewing the following detailed description and accompanying drawings, in which:

### BRIEF DESCRIPTION OF THE DRAWINGS

FIG. 1. It is an exploded view illustrating a planar dissolved oxygen sensing electrode according to a preferred embodiment of the present invention;

FIG. 2 is a cross sectional view illustrating the oxygen sensing layer of the planar dissolved oxygen sensing electrode according to the present invention;

FIG. 3 shows an exemplary electrochemical cyclic voltammetry of the planar dissolved oxygen sensing electrode according to the present invention;

FIG. 4 shows an exemplary electrochemical cyclic voltammetry of the conventional dissolved oxygen sensing electrode;

FIG. 5 shows the result of the current sensing sensitivity of the present sensing electrode and the conventional sensing electrode while the working potential of the electrochemical cyclic voltammetry in FIG. 3 is set at −0.2 V;

FIG. 6 shows the result of the current sensing sensitivity of the present sensing electrode and the conventional sensing electrode while the working potential of the electrochemical cyclic voltammetry in FIG. 4 is set at −0.2 V;

FIG. 7 shows the sensing sensitivities of the present planar dissolved oxygen sensing electrode and the conventional sensing electrode; and

FIG. 8 is a flow chart illustrating a manufacturing method of the planar dissolved oxygen sensing electrode according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a planar dissolved oxygen (DO) sensing electrode. The planar dissolved oxygen (DO) sensing electrode includes an insulating base plate, an electric-conductive layer, an oxygen sensing layer, a reference sensing layer and an electrolyte layer. In the present invention, the reference sensing layer can be for example but not limited to a silver/silver chloride reference sensing layer. The electric-conductive layer is disposed on the planar surface of the insulating base plate. The electric-conductive layer includes a first conductive part, a second conductive part, a first reaction zone and a second reaction zone. The first conductive part and the second conductive part are insulated and apart from each other, and connected with the first reaction zone and the second reaction zone, respectively. The oxygen sensing layer is disposed on the first reaction zone. The oxygen sensing layer includes plural catalyst particles and a polymer matrix and the plural catalyst particles are dispersed in the polymer matrix. The reference sensing layer is disposed on the second reaction zone. The electrolyte layer is disposed on and covers the oxygen sensing layer and the silver/silver chloride reference sensing layer. The composites of the catalyst particles and the polymer matrix are constructed on the electric-conductive layer to form the planar oxygen sensing layer by means of an electrophoresis, an electrical polymerization, a droplet coating or a screen printing technique. Moreover, without the loss of the accuracy, the volume of the planar dissolved oxygen sensing electrode is greatly reduced, and the planar dissolved oxygen sensing electrode has high selectivity and high sensitivity.

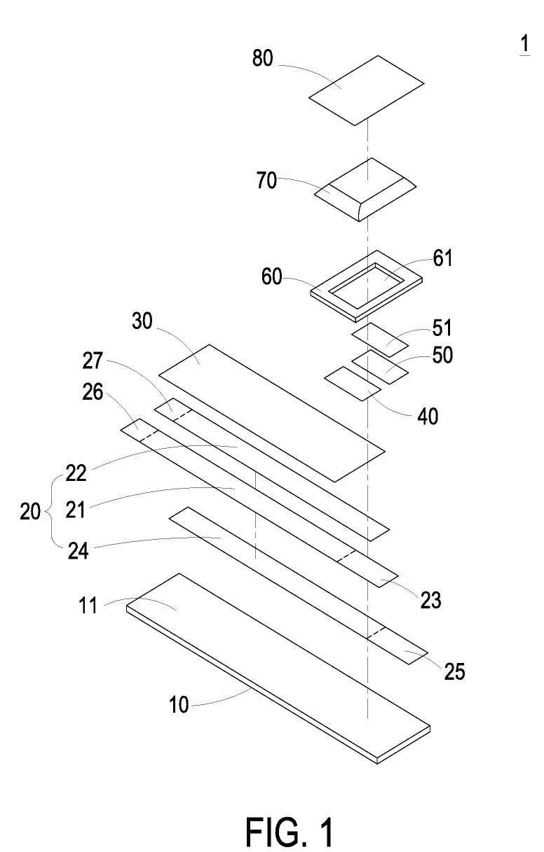

FIG. 1 is an exploded view illustrating a planar dissolved oxygen sensing electrode according to a preferred embodiment of the present invention. As shown in FIG. 1, the planar dissolved oxygen sensing electrode (hereinafter referred as the sensing electrode) 1 includes an insulating base plate 10, an electric-conductive layer 20, an insulating and waterproof layer 30, an oxygen sensing layer 40, a reference sensing layer and 50, a pad 60, an electrolyte layer 70 and a gas diffusion layer 80. The insulating base plate 10 includes at least one planar surface 11. The electric-conductive layer 20 includes a first conductive part 21 and a second conductive part 22 disposed on the planar surface 11 of the insulating base plate 10, respectively, and insulated and apart from each other. In the embodiment, the first conductive layer 21 and the second conductive layer 22 are preferably disposed on the same planar surface 11. The first conductive part 21 includes a first reaction zone 23. In the embodiment, the reference sensing layer 50 can be for example but not limited to a silver/silver chloride reference sensing layer. Relative to the reference sensing layer 50 formed by the silver/silver chloride, the electric-conductive layer 20 further includes a conductive silver layer 24 disposed between the second conductive part 22 and the insulating base plate 10. The second conductive part 22 of the electric-conductive layer 20 partially covers the conductive silver layer 24, and the conductive silver layer 24 includes a portion exposed from the second conductive part 22 and configured as the second reaction zone 25. The insulating and waterproof layer 30 is disposed on the electric-conductive layer 20, partially covers the first conductive part 21 of the electric-conductive layer 20, and covers the second conductive part 22. The first conductive part 21 includes a portion exposed from the insulating and waterproof layer 30 and configured as the first reaction zone 23, and the insulating and waterproof layer 30 doesn't cover or shield the second reaction zone 25 of the conductive silver layer 24. In the embodiment, the first reaction zone 23 of the first conductive part 21 and the second reaction zone 25 of the conductive silver layer 24 are disposed nearby with a gap so as to facilitate the miniaturization of the entire structure. Preferably, the first reaction zone 23 and the second reaction zone 24 are located at the ends of the first conductive part 21 and the conductive silver layer 24, respectively. The oxygen sensing layer 40 and the reference sensing layer 50 are disposed on the first reaction zone 23 of the conductive part 21 and the second reaction zone 25 of the conductive silver layer 24, respectively. In other words, the insulating and waterproof layer 30 and the oxygen sensing layer 40 cover over the first conductive part 21 together, and the reference sensing layer 50 covers the second reaction zone 25 of the conductive silver layer 24. In an embodiment, the sensing electrode 1 further includes a solid-state chloride ion protection layer 51 disposed on the reference sensing layer 50 for maintaining the concentration of chloride ion on the surface of the reference sensing layer 50 at a fixed value. The solid-state chloride ion protection layer 51 includes a gel material attached with a liquid electrolyte containing the chloride ion and is constructed on the surface of the reference sensing layer 50. The gel material includes for example but not limited to an agarose, a polyacrylamide, a gelatin, a calcium alginate, a polyvinyl butyral (PVB) resin (BUTVAR B-98), and the other gel materialsto. The liquid electrolyte of the solid-state chloride ion protection layer 51 can be for example but not limited to a potassium chloride (KCl) aqueous solution, a sodium chloride (NaCl) aqueous solution and a hydrochloric acid (HCl) aqueous solution. In an embodiment, 3M sodium chloride (NaCl) aqueous solution and 2 wt. % polyvinyl butyral (PVB) resin (BUTVAR B-98) ethanol solution are mixed uniformly, and then the solid-state chloride ion protection layer 51 is fixed on the surface of the reference sensing layer 50 by means of droplet coating and further dried to form a film. It is noted that the insulating and waterproof layer 30, the oxygen sensing layer 40 and the reference sensing layer 50 can be constructed on the same planar surface, and the constructing order is adjustable according to the practical requirements. The present invention is not limited to the constructing order of the three layers. In an embodiment, the first reaction zone 23 and the second reaction zone 25 are connected with the ends of the first conductive part 21 and the second conductive part 22, respectively, and the first conductive part 21 and the second conductive part 22 further include a working electrode connection zone 26 and a counter electrode connection zone 27 disposed on the other ends opposite the ends where the first reaction zone 23 and the second reaction zone 25 are located at. The working electrode connection zone 26 and a counter electrode connection zone 27 are exposed from the insulating and waterproof layer 30, and connected to the connection wires (not shown) for forming a sensing circuit. However, it is not the necessary technical feature to limit the present application, and not redundantly described herein. Besides, the electrolyte layer 70 is disposed on the oxygen sensing layer 40 and the reference sensing layer 50 and covers on the oxygen sensing layer 40 and the reference sensing layer 50 at the same time. In the embodiment, the sensing electrode 1 further includes a pad 60 having an opening 61. The pad 60 is disposed around the oxygen sensing layer 40, the reference sensing layer 50 and the electrolyte layer 70. Consequently, the electrolyte layer 70 passes through the opening 61, is accommodated in the interior of the opening 61, and contacts with the oxygen sensing layer 40 and the reference sensing layer 50. In addition, the sensing electrode 1 further includes a gas diffusion layer 80 disposed on the electrolyte layer 70 and attached to the pad 60, so as to hold the electrolyte layer 70 among the gas diffusion layer 80, the oxygen sensing layer 40 and the reference sensing layer 50. Consequently, the targeted sensing ions can be transmitted from the gas diffusion layer 80 through the electrolyte layer 70 to the oxygen sensing layer 40 and the reference sensing layer 50, respectively. In an embodiment, the 0.1 M tris (hydroxymethyl) aminomethane (Tris) aqueous solution is dispensed in a fixed dispensing volume of 250 μL by a gel dispenser to fill the interior (the accommodation space for the electrolyte) of the opening 61 of the pad 60. Consequently, the production of the electrolyte layer 70 is completed and the sensing electrode 1 of the present invention is constructed.

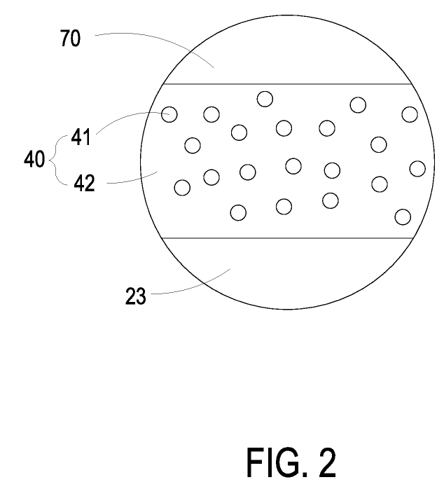

In the above embodiment, the oxygen sensing layer 40 is constructed on the first reaction zone 23 of the first conductive part 21 of the electric-conductive layer 20. FIG. 2 is a cross sectional view illustrating the oxygen sensing layer of the planar dissolved oxygen sensing electrode according to the present invention. As shown in FIG. 2, the oxygen sensing layer 40 includes plural catalyst particles 41 and a polymer matrix 42. The poly matrix 42 is formed by for example but not limited to a polyaniline, a polypyrrole, a polyaniline-polypyrrole copolymer, a sulfonated tetrafluorethylene copolymer (Nafion), a chitosan or a hydroxyethyl-cellulose. On the other hand, the catalyst particle is formed by for example but not limited to at least one selected from a group consisting of a single-metal component M₁, a binary-metal component M₁-M₂, a ternary-metal component M₁-M₂-M₃, a single-metal-oxide component M₁O_{X}, a binary-metal-oxide component M₁O_{X}-M₂O_{X}, and a composite material of a metal and a metal oxide M₁-M₁O_{X}, wherein 0<X<3, and M₁, M₂ and M₃ are one selected from a group consisting of a platinum (Pt), a gold (Au), a palladium (Pd), a silver (Ag), an iridium (Ir), a bismuth (Bi), a lithium (Li), an iron (Fe), a cobalt (Co), a nickel (Ni), a copper (Cu), an aluminum (Al), a chromium (Cr), a titanium (Ti), a manganese (Mn), an antimony (Sb), a zinc (Zn), a zirconium (Zr), a gallium (Ga), a molybdenum (Mo), a ruthenium (Ru), a rhodium (Rh), a tin (Sn), an indium (In), an osmium (Os), a tantalum (Ta), a tungsten (W), a cerium (Ce) and a yttrium (Y). In an embodiment, the catalyst particles 41 include the binary-metal component, the ternary-metal component and the binary-metal-oxide component, and the molar ratio of those metal elements are more than 0 and less than 100%. In an embodiment, the catalyst particles 41 are formed by plural Pt—Pd—Au ternary nano metal particles, and the average mean particle diameter of the catalyst particle 41 is ranged from 0.5 nm to 100 μm. The catalyst particles 41 and the polymer matrix 42 are formed on the first reaction zone 23 of the first conductive part 21 of the electric-conductive layer 20 to construct the planar oxygen sensing layer 40 by means of an electrophoresis, an electrical polymerization, a droplet coating or a screen printing technique.

In the embodiment, the sensing electrode 1 is used to monitor the dissolved oxygen amount in the aqueous solution according to the polarographic analysis method. The sensing theory is based on a working potential between the cathode and the anode, wherein the working potential is ranged from 1 V to −1 V. While the oxygen molecules reach the cathode plane, an electrochemical oxygen reduction reaction (as shown in the equation 1) is generated, and an electrochemical oxidation reaction (as shown in the equation 2) is generated at the anode of the reference electrode.

O₂+H₂O+4e⁻→4OH⁻ (1)

4Cl⁻+4Ag−4e⁻→4AgCl (2)

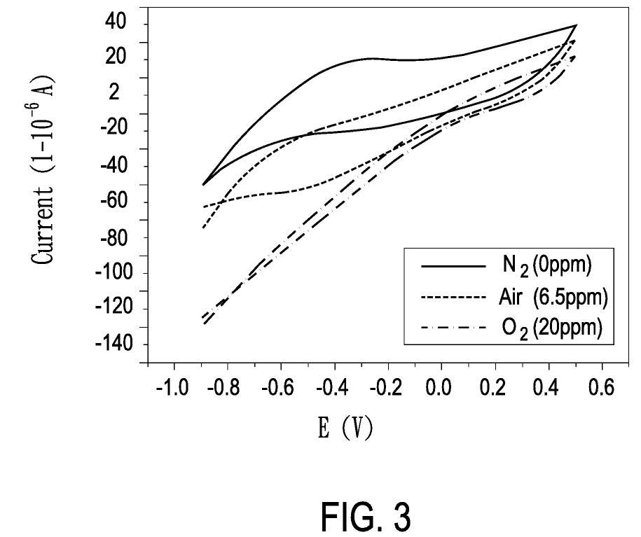

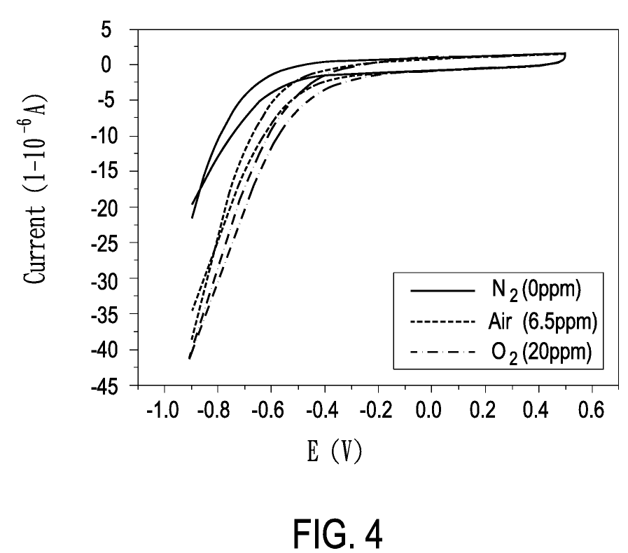

FIG. 3 shows an exemplary electrochemical cyclic voltammetry of the planar dissolved oxygen sensing electrode according to the present invention. The structure of the oxygen sensing layer 40 of the sensing electrode 1 is shown in FIG. 2, and the oxygen sensing layer 40 constructed by the Pt—Pd—Au ternary nano metal as the catalyst particles 41 and the sulfonated tetrafluorethylene copolymer (Nafion) as the polymer matrix 42 is formed on the electric-conductive layer 20 (as shown in FIG. 1) constructed by the screen printing carbon. FIG. 4 shows an exemplary electrochemical cyclic voltammetry of the conventional dissolved oxygen sensing electrode, wherein the oxygen sensing layer of the sensing electrode is constructed on the screen-printing carbon electric-conductive layer by sputtering a golden film (with the thickness of 30 nm). As shown in FIGS. 3 and 4, the aqueous solutions in different gas conditions (N₂, Air, O₂) include different dissolved oxygen amounts (0 ppm, 6 ppm, 20 ppm). The special sensing structure of the present oxygen sensing layer 40 constructed by the Pt—Pd—Au ternary nano metal as the catalyst particles 41 and the sulfonated tetrafluorethylene copolymer (Nafion) as the polymer matrix 42 has the advantage of reducing the working potential to −0.2 V for the oxygen reduction reaction in the polarographic analysis method. It means that the oxygen sensing layer 40 including the Pt—Pd—Au ternary nano metal as the catalyst particles 41 and the sulfonated tetrafluorethylene copolymer (Nafion) as the polymer matrix 42 can catalyze the oxygen reduction reaction and reduce the activation energy and the required driving force. In contrast, the oxygen reduction ability of the traditional oxygen sensing layer constructed by the sputtering gold film is poor under the condition at −0.2 V and thus the sensitivity thereof is poor.

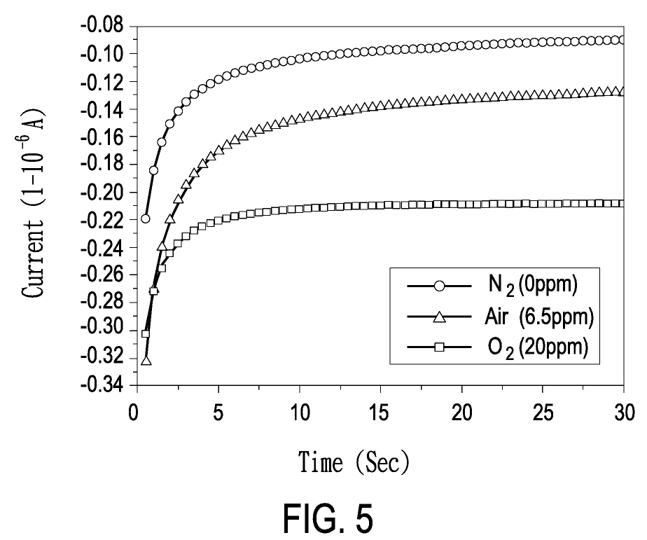

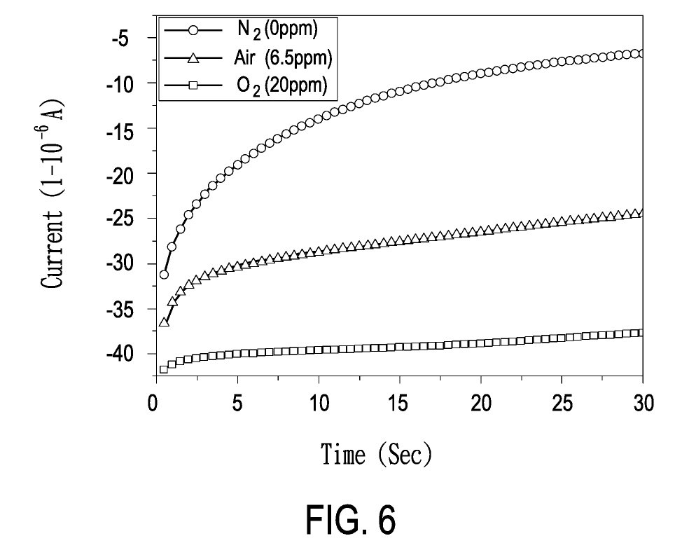

FIGS. 5 and 6 show the results of the current sensing sensitivity of the present sensing electrode and the conventional sensing electrode while the working potentials of the electrochemical cyclic voltammetry in FIGS. 3 and 4 are set at −0.2 V. As shown in FIGS. 5 and 6, the current signal intensity of the oxygen reduction generated at the present oxygen sensing layer 40 with the Pt—Pd—Au ternary nano metal as the catalyst particles 41 and the sulfonated tetrafluorethylene copolymer (Nafion) as the polymer matrix 42 is about 100 times larger than the current signal intensity of the oxygen reduction generated at the conventional oxygen sensing layer constructed by the sputtering golden film.

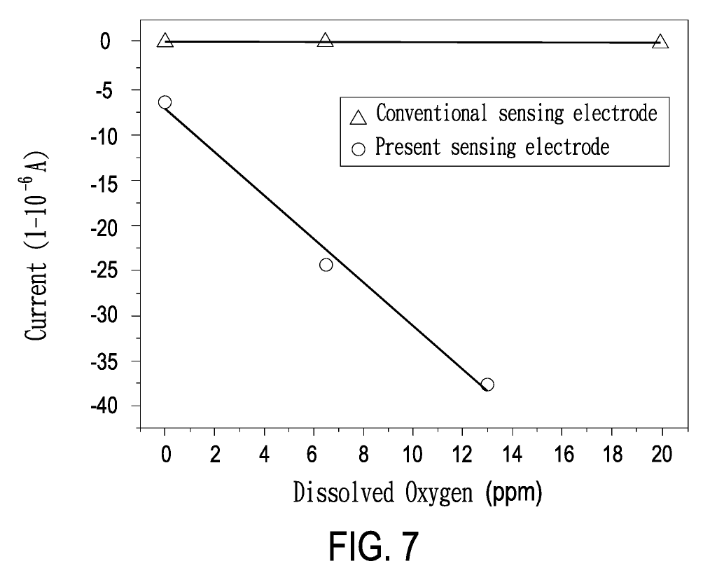

FIG. 7 shows the sensing sensitivities of the present planar dissolved oxygen sensing electrode and the conventional sensing electrode. Similarly, the present sensing electrode 1 has the oxygen sensing layer 40 constructed by the Pt—Pd—Au ternary nano metal as the catalyst particles 41 and the sulfonated tetrafluorethylene copolymer (Nafion) as the polymer matrix 42, and the conventional sensing electrode has the oxygen sensing layer constructed by the sputtering golden film (with the thickness of 30 nm). As shown in FIG. 7 and Table 1, the sensitivity of the present sensing electrode 1 having the oxygen sensing layer 40 with the Pt—Pd—Au ternary nano metal as the catalyst particles 41 and the sulfonated tetrafluorethylene copolymer (Nafion) as the polymer matrix 42 for sensing the dissolved oxygen is −2.39 μA/ppm, and the sensitivity of the conventional sensing electrode having the sputtering golden film for sensing the dissolved oxygen is −0.0059 μA/ppm. It is obviously that the sensitivity of the planar dissolved oxygen sensing electrode 1 of the present invention can be enhanced for sensing the dissolved oxygen in the aqueous solution.

TABLE 1
Comparison of the planar type dissolved oxygen sensing
electrode according to the present invention and
the conventional golden film sensing electrode.

| The present planar dissolved | | The conventional golden | |
|---|---|---|---|
| oxygen sensing electrode | | film sensing electrode | |
| linearity range | 0-13 ppm | linearity range | 0-20 ppm |
| linearity | R² = 0.98575 | linearity | R² = 0.99998 |
| sensitivity | −2.387 μA/ppm | sensitivity | −0.00591 μA/ppm |

It is noted that the sensitivity of the sensing electrode 1 can be improved for sensing the dissolved oxygen effectively by utilizing the planar structure and constructing the oxygen sensing layer 40 by the catalyst particles 41 and the polymer matrix 42. The entire volume of the sensing electrode 1 is reduced, and the cost of the manufacturing raw materials is reduced. The planar dissolved oxygen sensing electrode of the present invention with high selectivity and high sensitivity can be applied in the fields of the medicine, the biochemistry, the chemistry, the agriculture, the environmental and others. For example, it can be applied to monitor the variation of the dissolved oxygen concentrations during the planting process of hydroponic plants, the dissolved oxygen amount in the blood, the dissolved oxygen amount in the eye, the dissolved oxygen amount for the water quality of the aquaculture, or the specific biological indicators (e.g. glucose) by means of combining the specific enzymes.

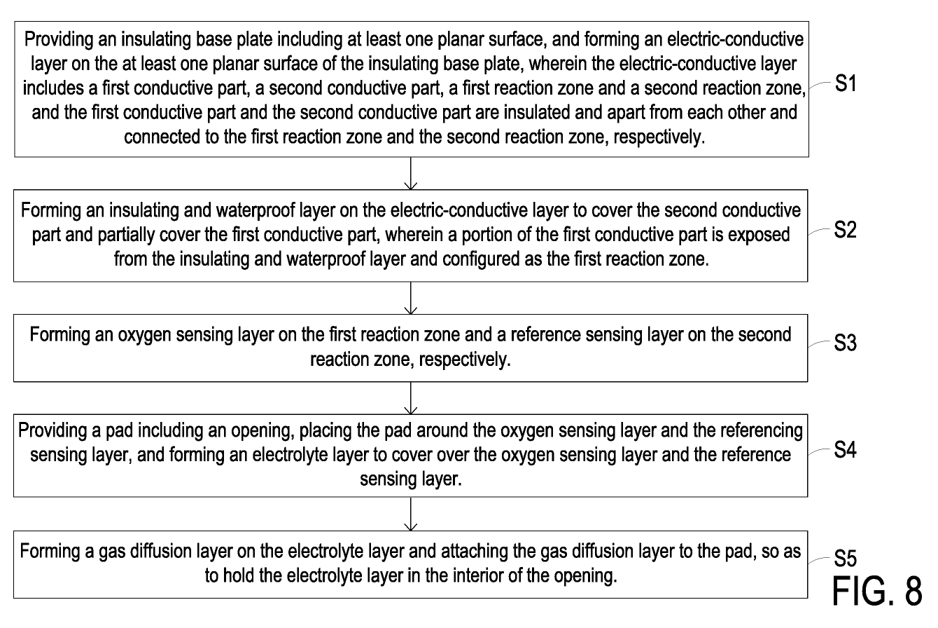

On the other hand, according to the planar dissolved oxygen sensing electrode described in the above embodiments, a manufacturing method of the planar dissolved oxygen sensing electrode is provided. FIG. 8 is a flow chart illustrating a manufacturing method of the planar dissolved oxygen sensing electrode according to the present invention. Please refer to FIGS. 1 and 8. Firstly, at the step S1, an insulating base plate 10 including at least one planar surface 11 is provided and an electric-conductive layer 20 is formed on the at least one planar surface 11 of the insulating base plate 10. The electric-conductive layer 20 includes a first conductive part 21 and a second conductive part 22 disposed on the planar surface 11 of the insulating base plate 10, respectively, by for example but not limited to a screen-printing or a sputtering technique, and the first conductive part 21 and the second conductive part 22 are insulated and apart from each other. The first conductive part 21 includes a first reaction zone 23. In the embodiment, before the first conductive part 21 and the second conductive part 22 of the electric-conductive layer 20 are formed, a conductive silver layer 24 is pre-formed by for example but not limited to a screen-printing or a sputtering technique and disposed between the second conductive part 22 of the electric-conductive layer 20 and the insulating base plate 10. The second conductive part 22 of the electric-conductive layer 20 covers over the conductive silver layer 24 and is connected with the conductive silver layer 24. The conductive silver layer 24 includes a portion exposed from the second conductive part 22 of the electric-conductive layer 20 and configured as a second reaction zone 25. The second reaction zone 25 is connected to the second conductive part 22 through the conductive silver layer 24. Thus, the first conductive part 21, the second conductive part 22, the first reaction zone 23 and the second reaction zone 25 are constructed on the planar surface 11 of the insulating base plate 10 by performing the step S1. Then, at the step S2, an insulating and waterproof layer 30 is formed on the electric-conductive layer 20 to partially cover the first conductive part 21 of the electric-conductive layer 20 and thus the portion of the first conductive part 21 exposed from the insulating and waterproof layer 30 is configured as the first reaction zone 23. At the same time, the insulating and waterproof layer 30 also covers the second conductive part 22, but uncovers the second reaction zone 25. In the embodiment, the insulating and waterproof layer 30 is formed by for example but not limited to a screen-printing or a chemical vapor deposition (CVD) technique to partially cover on the electric-conductive layer 20, and thus the uncovered portion of the electric-conductive layer 20 is configured as the first reaction zone 23 of the first conductive part 21 and the second reaction zone 24 of the conductive silver layer 24 is exposed from the insulating and waterproof layer 30. In the embodiment, the first reaction zone 23 of the first conductive part 21 and the second reaction zone 25 of the conductive silver layer 24 are disposed nearby with a gap so as to facilitate the miniaturization of the entire structure. In an embodiment, the first reaction zone 23 and the second reaction zone 25 are connected with the ends of the first conductive part 21 and the second conductive part 22, respectively, and the first conductive part 21 and the second conductive part 22 further include a working electrode connection zone 26 and a counter electrode connection zone 27 disposed on the other ends opposite the ends where the first reaction zone 23 and the second reaction zone 25 are located at, exposed from the insulating and waterproof layer 30, and connected to the connection wires (not shown) for forming a sensing circuit. However, it is not the necessary technical feature to limit the present, and not redundantly described herein. In addition, at the step S3, the oxygen sensing layer 40 and the reference sensing layer 50 are formed on the first reaction zone 23 and the second reaction zone 25, respectively. The reference sensing layer 50 can be for example but not limited to a silver/silver chloride reference sensing layer. In the embodiment, the insulating and waterproof layer 30, the oxygen sensing layer 40 and the reference sensing layer 50 are constructed together to cover on the electric-conductive layer 20 and the conductive silver layer 24. The forming sequences of the insulating and waterproof layer 30, the oxygen sensing layer 40 and the reference sensing layer 50 are not limited, can be adjustable according to the practical requirements. The details are not redundantly described herein. Afterward, at the step S4, the electrolyte layer 70 is formed to cover the oxygen sensing layer 40 and the reference sensing layer 50. In the embodiment, the accommodation space of the electrolyte layer 70 is further defined by an opening 61 of a pad 60. The pad 60 is disposed around the oxygen sensing layer 40, the reference sensing layer 50 and the electrolyte layer 70. Consequently, the electrolyte layer 70 passes through the opening 61, is accommodated in the inner of the opening 61, and contacts with the oxygen sensing layer 40 and the reference sensing layer 50. The pad 60 can be formed by the materials for example but not limited to the polyethylene terephthalate (PET). In addition, the electrolyte layer 70 can be constructed by filling with for example but not limited to 1 M potassium chloride (KCl) aqueous solution in the accommodation space defined by the opening 61 of the pad 60. Finally, at the step S5, a gas diffusion layer 80 is formed on the electrolyte layer 70 and attached to the pad 60, so as to hold the electrolyte layer 70 among the gas diffusion layer 80, the oxygen sensing layer 40 and the reference sensing layer 50. Namely, the electrolyte layer 70 is accommodated in the accommodation space defined by the opening 61 of the pad 60. In the embodiment, the gas diffusion layer 80 can be for example but not limited to a porous ceramic film.

In the embodiment, the conductive silver layer 24 is formed by for example but not limited to a screen-printing silver slurry or a sputtering silver film. The insulating base plate 10 is formed by for example but not limited to a polyethylene terephthalate (PET) substrate or a ceramic substrate. In an embodiment, the conductive silver layer 24 is printed on the insulating base plate 10 firstly and then dried at 60° C. to 140° C. for 40 to 80 minutes to complete the production thereof. On the other hand, the electric-conductive layer is formed by for example but not limited to a sputtering metal film, and its material is one selected from a group consisting of a screen-printing silver-carbon conductive mixing slurry, a gold paste, a palladium paste, a silver paste, a conductive carbon slurry, a gold, a palladium, a platinum, a gold-palladium alloy, a silver and the combinations thereof. In an embodiment, at the step S1, the electric-conductive layer 20 is formed on the insulating base plate 10 by a printing method to partially cover the conductive silver layer 24 and partially expose the conductive silver layer 24 for forming the second reaction zone 25, and then dried at for example 60° C. to 140° C. for 40 to 80 minutes. Consequently, the electric-conductive layer 20 and the conductive silver layer 24 are constructed on the insulating base plate 10.

In the embodiment, the first reaction zone 23 of the first conductive part 21 of the electric-conductive layer 20 is covered by the oxygen sensing layer 40, and the second reaction zone 25 of the conductive silver layer 24 is covered by the reference sensing layer 50. Consequently, the first reaction zone 23 and the second reaction zone 25 are configured as the oxygen reduction reaction zone and the silver oxidation reaction zone, respectively, so as to transmit the voltage variations of the electrochemical membrane voltage generated by the oxygen sensing layer 40 and the reference sensing layer 50, respectively, and transmit the electric signal through first conductive part 21 and the second conductive part 22 of the electric-conductive layer 20 to the connection wires. In an embodiment, the connection wires are further connected to a measuring device (not shown), and the measuring device can display and calculate the oxygen concentration corresponding to the variations of the sensing voltage. Consequently, it can be utilized easily. In an embodiment, the first reaction zone 23 and the second reaction zone 25 respectively covered by the oxygen sensing layer 40 and the reference sensing layer 50 are insulated and apart from each other, and disposed nearby with a gap so as to facilitate the miniaturization of the sensing electrode 1.

Furthermore, in the embodiment, the insulating and waterproof layer 30 can be formed by for example but not limited to insulating and waterproof materials, such as a para-xylene polymer, a screen-printing insulating paste, or a screen printing UV insulating paste. In an embodiment, the insulating and waterproof layer 30 is formed by a screen-printing insulating paste, and dried at for example 60° C. to 140° C. for 40 to 80 minutes. The insulating and waterproof layer 30 partially covers the first conductive part 21. The portion of the first conductive part 21 exposed from the insulating and waterproof layer 30 is configured as the first reaction zone 23, and the second reaction zone 25 of the conductive silver layer 24 is exposed from the insulating and waterproof layer 30. With respect to the first reaction zone 23 and the second reaction zone 25, the insulating and waterproof layer 30 is adjustable to cover the portions of the electric-conductive layer 20, so as that a working electrode connection zone 26 and a counter electrode connection zone 27 are formed on the other ends of the first conductive part 21 and the second conductive part 22, respectively and connected to the connection wires (not shown) for forming a sensing circuit. The present invention is not limited to this technical feature, and are not redundantly described herein.

In the embodiment, the oxygen sensing layer 40 is formed by for example but not limited to an electrophoresis, an electrical polymerization, a droplet coating or a screen printing technique. In the embodiment, the oxygen sensing layer 40 includes plural catalyst particles 41 and a polymer matrix 42. The poly matrix 42 is formed by for example but not limited to a polyaniline, a polypyrrole, a polyaniline-polypyrrole copolymer, a sulfonated tetrafluorethylene copolymer (Nafion), a chitosan or a hydroxyethyl-cellulose. On the other hand, the catalyst particle is formed by at least one selected from a group consisting of a single-metal component M₁, a binary-metal component M₁-M₂, a ternary-metal component M₁-M₂-M₃, a single-metal-oxide component M₁O_{X}, a binary-metal-oxide component M₁O_{X}-M₂O_{X}, and a composite material of a metal and a metal oxide M₁-M₁O_{X}, wherein 0<X<3, and M₁, M₂ and M₃ are one selected from a group consisting of a platinum (Pt), a gold (Au), a palladium (Pd), a silver (Ag), an iridium (Ir), a bismuth (Bi), a lithium (Li), an iron (Fe), a cobalt (Co), a nickel (Ni), a copper (Cu), an aluminum (Al), a chromium (Cr), a titanium (Ti), a manganese (Mn), an antimony (Sb), a zinc (Zn), a zirconium (Zr), a gallium (Ga), a molybdenum (Mo), a ruthenium (Ru), a rhodium (Rh), a tin (Sn), an indium (In), an osmium (Os), a tantalum (Ta), a tungsten (W), a cerium (Ce) and a yttrium (Y). In an embodiment, the catalyst particles 41 include the binary-metal component, the ternary-metal component and the binary-metal-oxide component, and the molar ratio of those metal elements are more than 0 and less than 100%. In an embodiment, the catalyst particles 41 are formed by plural Pt—Pd—Au ternary nano metal particles, and the average mean particle diameter of the catalyst particle 41 is ranged from 0.5 nm to 100 μm. The catalyst particles 41 and the polymer matrix 42 are formed on the first reaction zone 23 of the first conductive part 21 of the electric-conductive layer 20 to construct the planar oxygen sensing layer 40 by means of an electrophoresis, an electrical polymerization, a droplet coating or a screen printing technique. In an embodiment, the sulfonated tetrafluorethylene copolymer (Nafion) is selected to be the polymer matrix 42 and mixed with the deionized water to form an aqueous solution of the polymer matrix 42 with a concentration ranged from 01. wt. % to 2 wt. %. On the other hand, the plural catalyst particles includes the Pt—Pd—Au ternary nano metal particles having the average mean particle diameter ranged from 0.5 nm to 100 μm, and mixed with the aqueous solution of the polymer matrix 42. The mixing concentration is ranged from 0.01 mg/mL to 2 mg/mL. The suspended slurry formed by mixing the catalyst particles 41 and the polymer matrix 42 is prepared by an ultrasonic atomizer at 4° C. under ice-cooling. Consequently, the catalyst particles 41 are uniformly dispersed in the aqueous solution of the polymer matrix 42. Afterward, the suspending slurry of the catalyst particles 41 and the polymer matrix 42 are dropped by the droplet coating method to cover over the first reaction zone 23 with the droplet volume ranged from 20 μL to 60 μL, dried at for example 30° C. to 60° C. for 2 to 10 hours, and then vacuum dried at for example 40° C. to 60° C. for 6 to 18 hours. Consequently, the production of the oxygen sensing layer 40 is completed.

On the other hand, the reference sensing layer 50 can be formed by for example but not limited to a droplet coating method, a sputtering method, an electrodeposition method or a screen-printing thick-film technique to be constructed on the second reaction zone 25 of the conductive-silver layer 24. The material of the reference sensing layer 50 can be for example but not limited to a silver/silver chloride (Ag/AgCl), a mercury/mercury chloride (Hg/HgCl) or other metal oxide, such as an iridium oxide (IrO₂), a ruthenium oxide (RuO₂), a platinum oxide (PtO_{X}), a palladium oxide (PdO_{X}), a tin oxide (SnO₂), a tantalum oxide (Ta₂O₅), a rhodium oxide (RhO₂), a osmium oxide (OsO2), titanium oxide (TiO₂), a mercury oxide (Hg₂O) or an antimony oxide (Sb₂O₃). In an embodiment, the reference sensing layer 50 includes the silver/silver chloride (Ag/AgCl) and produced by for example but not limited to an electrochemical constant voltage method. The working voltage is ranged from 0.6 V to 1.0 V and the oxidization time is ranged from 60 seconds to 180 seconds. The oxidized reference sensing layer 50 is rinsed by the deionized water, and then dried at 80° C. for one hour to remove the redundant water. Consequently, the production of the silver/silver chloride (Ag/AgCl) reference sensing layer 50 is completed. In the embodiment, the electrolyte solution for the electric oxidation includes for example but not limited to a potassium chloride (KCl) aqueous solution with the concentration ranged from 0.1 M to 3 M. It is not the necessary technical feature to limit the present invention, and not redundantly described herein.

In an embodiment, the sensing electrode 1 further includes a protection layer, for example but not limited to a solid-state chloride ion protection layer 51, disposed on the reference sensing layer 50. The solid-state chloride ion protection layer 51 includes a gel material and a liquid electrolyte containing the chloride ion. The liquid electrolyte is attached to the gel material and then formed on the surface of the reference sensing layer 50 by for example but not limited to a droplet coating or a screen printing thick-film technique. The gel material of the solid-state chloride ion protection layer 51 can be for example but not limited to an agarose, a polyacrylamide, a gelatin, a calcium alginate, a polyvinyl butyral (PVB) resin (BUTVAR B-98), or the other gel materials. The liquid electrolyte of the solid-state chloride ion protection layer 51 can be for example but not limited to a hydrochloric acid (HCl) aqueous solution, a potassium chloride (KCl) aqueous solution or a sodium chloride (NaCl) aqueous solution, and the concentration of the electrolyte is ranged from 0.5 wt. % to 5 wt. %. In an embodiment, 3M sodium chloride (NaCl) aqueous solution and 2 wt. % polyvinyl butyral (PVB) resin (BUTVAR B-98) ethanol solution are mixed uniformly, and then the solid-state chloride ion protection layer 51 is fixed on the surface of the reference sensing layer 50 by means of droplet coating and further dried at 60° C. for one hour. Consequently, the production of the solid-state chloride ion protection layer 51 is completed.

In the above embodiments, the pad 60 is disposed around the oxygen sensing layer 40 and the reference sensing layer 50, and the interior of the opening 61 of the pad 60 is configured as an accommodation space for filling with the electrolyte layer 70. In an embodiment, the pad 60 can be formed by for example but not limited to a polyethylene terephthalate (PET) or a poly vinyl chloride (PVC). In an embodiment, the pad 60 is formed by the PET with the thickness of 0.35 mm. The pad 60 has a backside with an adhesive tape, which is attached to the planar surface 11 of the insulating base plate 10 and disposed around the periphery of the oxygen sensing layer 40 and the reference sensing layer 50. Then, it is pressed and hold for 12 hours by a rolling machine so as to make it adhered firmly. The interior of the opening 61 of the pad 60 is further configured as the accommodation space for filling with the electrolyte layer 70.

In the above embodiment, the electrolyte layer 70 is constructed by the materials of the liquid electrolyte, which can be for example but not limited to a hydrochloric acid aqueous solution, a potassium chloride aqueous solution, a potassium hydroxide aqueous solution, a sodium chloride aqueous solution, a phosphate buffer aqueous solution, a tris (hydroxymethyl) aminomethane (Tris) aqueous solution, a perchloric acid aqueous solution or a sulfuric acid aqueous solution, and the concentration of liquid electrolyte is ranged from 0.01 M to 0.1 M. In an embodiment, the electrolyte layer 70 is constructed by the materials of the solid electrolyte. The electrolyte is attached in a gel material for example but not limited to the electrolyte attached an agarose, a polyacrylamide, a gelatin or a calcium alginate. In an embodiment, the 0.1 M tris (hydroxymethyl) aminomethane (Tris) aqueous solution is dispensed in a fixed dispensing volume of 250 μL by a gel dispenser to fill the interior (the accommodation space for the electrolyte) of the opening 61 of the pad 60. Consequently, the production of the electrolyte layer 70 is completed.

Moreover, in the above embodiments, the gas diffusion layer 80 is constructed by the material for example but not limited to a cellulose acetate, a silicone rubber, a polytetrafluoroethylene (PTFE), a copolymer of fluorinated ethylene propylene (FEP), a polydimethylsiloxane (PDMS), a polyvinyl chloride (PVC), a natural rubber or the combinations thereof. In the embodiment, the thickness of the gas diffusion layer 80 is ranged from 0.1 μm to 30 μm. In an embodiment, the gas diffusion layer 80 is formed by a PTFE film with the thickness of 10 μm. The backside of the PTFE film adhered with the adhesive tape is attached to the pad 60 and cover over the electrolyte layer 70, so that the electrolyte layer 70 is sealed in the opening 61 of the pad 60. Consequently, the sensing electrode 1 of the present invention is completed. In addition, the material of the gas diffusion layer 80 can be for example but not limited to a silicate mineral, an aluminum silicate mineral, a diatomaceous earth, a silicon carbide, an emery, a silicon dioxide, a metal oxide or the combinations thereof. In an embodiment, the gas diffusion layer 80 is formed by sintering the silicon carbide. Then, the outer periphery of the gas diffusion layer 80 is fixed by an O-ring (not shown) and the gas diffusion layer 80 is fastened to cover the interior (the accommodation space for the electrolyte) of the opening 61 of the pad 60. Moreover, it can be further sealed by an epoxy resin so as to achieve the waterproof effect. The present invention is not limited to this technical feature, and are not redundantly described herein.

In summary, a planar dissolved oxygen sensing electrode and a manufacturing method thereof are provided. The sensing sensitivity of the dissolved oxygen sensing electrode is improved by utilizing the planar structure and the composites of the catalyst particles and the polymer matrix. The oxygen sensing layer is constructed by the composites of the catalyst particles and the polymer matrix can enhance the sensitivity sensed by the conventional polarographic dissolved oxygen measurement. The planar sensing layers facilitates to reduce the entire volume of the sensing electrode and reduce the cost of the manufacturing raw materials. Consequently, the planar dissolved oxygen sensing electrode with high selectivity and high sensitivity can be applied in the fields of the medicine, the biochemistry, the chemistry, the agriculture, the environmental and others. For example, it can be applied to monitor the variation of the dissolved oxygen concentrations during the planting process of hydroponic plants, the dissolved oxygen amount in the blood, the dissolved oxygen amount in the eye, the dissolved oxygen amount for the water quality of the aquaculture, or the specific biological indicators (e.g. glucose) by means of combining the specific enzymes. Moreover, the structure is compact, the manufacturing process is simplified, and the cost is reduced, so as to facilitate to achieve the purpose of providing disposable sensing electrodes

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A planar dissolved oxygen sensing electrode, comprising:
an insulating base plate including at least one planar surface;
an electric-conductive layer disposed on the at least one planar surface, wherein the electric-conductive layer includes a first conductive part, a second conductive part, a first reaction zone and a second reaction zone, wherein the first conductive part and the second conductive part are insulated and apart from each other and connected to the first reaction zone and the second reaction zone, respectively;
an oxygen sensing layer disposed on the first reaction zone, wherein the oxygen sensing layer includes plural catalyst particles and a polymer matrix and the plural catalyst particles are dispersed in the polymer matrix;
a reference sensing layer disposed on the second reaction zone; and
an electrolyte layer disposed on and covering the oxygen sensing layer and the reference sensing layer.

2. The planar dissolved oxygen sensing electrode according to claim 1, wherein the catalyst particle is formed by at least one selected from a group consisting of a single-metal component M₁, a binary-metal component M₁-M₂, a ternary-metal component M₁-M₂-M₃, a single-metal-oxide component M₁O_{X}, a binary-metal-oxide component M₁O_{X}-M₂O_{X}, and a composite material of a metal and a metal oxide M₁-M₁O_{X}, 0<X<3, and M₁, M₂ and M₃ are one selected from a group consisting of a platinum (Pt), a gold (Au), a palladium (Pd), a silver (Ag), an iridium (Ir), a bismuth (Bi), a lithium (Li), an iron (Fe), a cobalt (Co), a nickel (Ni), a copper (Cu), an aluminum (Al), a chromium (Cr), a titanium (Ti), a manganese (Mn), an antimony (Sb), a zinc (Zn), a zirconium (Zr), a gallium (Ga), a molybdenum (Mo), a ruthenium (Ru), a rhodium (Rh), a tin (Sn), an indium (In), an osmium (Os), a tantalum (Ta), a tungsten (W), a cerium (Ce) and a yttrium (Y).

3. The planar dissolved oxygen sensing electrode according to claim 1, wherein the catalyst particle has an average mean particle diameter ranged from 0.5 nm to 100 μm.

4. The planar dissolved oxygen sensing electrode according to claim 1, wherein the polymer matrix is one selected from a group consisting of a polyaniline, a polypyrrole, a polyaniline-polypyrrole copolymer, a sulfonated tetrafluorethylene copolymer, a chitosan and a hydroxyethyl-cellulose.

5. The planar dissolved oxygen sensing electrode according to claim 1, wherein the electric-conductive layer further comprises a conductive silver layer disposed between the insulating base plate and the second conductive part, wherein a portion of the conductive silver layer is exposed from the second conductive part and configured as the second reaction zone.

6. The planar dissolved oxygen sensing electrode according to claim 1, wherein the reference sensing layer is formed by at least one selected from a group consisting of a silver, a silver chloride, a mercury, a mercury chloride, an iridium oxide (IrO₂), a ruthenium oxide (RuO₂), a platinum oxide (PtO_{X}), a palladium oxide (PdO₂), a tin oxide (SnO₂), a tantalum oxide (Ta₂O₅), a rhodium oxide (RhO₂), a osmium oxide (OsO2), titanium oxide (TiO₂), a mercury oxide (Hg₂O) and an antimony oxide (Sb₂O₃),

7. The planar dissolved oxygen sensing electrode according to claim 1, further comprising a protection layer disposed on the reference sensing layer.

8. The planar dissolved oxygen sensing electrode according to claim 1, further comprising an insulating and waterproof layer disposed on the electric-conductive layer, covering the second conductive part and partially covering the first conductive part, wherein a portion of the first conductive part is exposed from the insulating and waterproof layer and configured as the first reaction zone.

9. The planar dissolved oxygen sensing electrode according to claim 1, further comprising a pad disposed on the at least one planar surface of the insulating base plate, wherein the pad includes an opening, the pad is disposed around the oxygen sensing layer and the reference sensing layer, and the electrolyte layer is accommodated in an interior of the opening.

10. The planar dissolved oxygen sensing electrode according to claim 9, further comprising a gas diffusion layer disposed on the electrolyte layer and attached to the pad for holding the electrolyte layer among the gas diffusion layer, the oxygen sensing layer and the hydroxide ion layer.

11. A manufacturing method of a planar dissolved oxygen sensing electrode, comprising steps of:
(a) providing an insulating base plate including at least one planar surface, and forming an electric-conductive layer on the at least one planar surface of the insulating base plate, wherein the electric-conductive layer includes a first conductive part, a second conductive part, a first reaction zone and a second reaction zone, and the first conductive part and the second conductive part are insulated and apart from each other and connected to the first reaction zone and the second reaction zone, respectively;
(b) forming an oxygen sensing layer on the first reaction zone and a reference sensing layer on the second reaction zone, respectively, wherein the oxygen sensing layer includes plural catalyst particles and a polymer matrix and the plural catalyst particles are dispersed in the polymer matrix; and
(c) forming an electrolyte layer to cover over the oxygen sensing layer and the reference sensing layer.

12. The manufacturing method of the planar dissolved oxygen sensing electrode according to claim 11, wherein the catalyst particle is formed by at least one selected from a group consisting of a single-metal component M₁, a binary-metal component M₁-M₂, a ternary-metal component M₁-M₂-M₃, a single-metal-oxide component M₁O_{X}, a binary-metal-oxide component M₁O_{X}-M₂O_{X}, and a composite material of a metal and a metal oxide M₁-M₁O_{X}, 0<X<3, and M₁, M₂ and M₃ are one selected from a group consisting of a platinum (Pt), a gold (Au), a palladium (Pd), a silver (Ag), an iridium (Ir), a bismuth (Bi), a lithium (Li), an iron (Fe), a cobalt (Co), a nickel (Ni), a copper (Cu), an aluminum (Al), a chromium (Cr), a titanium (Ti), a manganese (Mn), an antimony (Sb), a zinc (Zn), a zirconium (Zr), a gallium (Ga), a molybdenum (Mo), a ruthenium (Ru), a rhodium (Rh), a tin (Sn), an indium (In), an osmium (Os), a tantalum (Ta), a tungsten (W), a cerium (Ce) and a yttrium (Y).

13. The manufacturing method of the planar dissolved oxygen sensing electrode according to claim 11, wherein the catalyst particle has an average mean particle diameter ranged from 0.5 nm to 100 μm.

14. The manufacturing method of the planar dissolved oxygen sensing electrode according to claim 11, wherein the polymer matrix is one selected from a group consisting of a polyaniline, a polypyrrole, a polyaniline-polypyrrole copolymer, a sulfonated tetrafluorethylene copolymer, a chitosan and a hydroxyethyl-cellulose.

15. The manufacturing method of the planar dissolved oxygen sensing electrode according to claim 11, wherein the step (a) further comprises a step of (a1) forming a conductive silver layer between the insulating base plate and the second conductive part, wherein a portion of the conductive silver layer is exposed from the second conductive part and configured as the second reaction zone.

16. The manufacturing method of the planar dissolved oxygen sensing electrode according to claim 11, wherein the reference sensing layer is formed by at least one selected from a group consisting of a silver, a silver chloride, a mercury, a mercury chloride, an iridium oxide (IrO₂), a ruthenium oxide (RuO₂), a platinum oxide (PtO_{X}), a palladium oxide (PdO_{X}), a tin oxide (SnO₂), a tantalum oxide (Ta₂O₅), a rhodium oxide (RhO₂), a osmium oxide (OsO2), titanium oxide (TiO₂), a mercury oxide (Hg₂O) and an antimony oxide (Sb₂O₃), wherein the planar dissolved oxygen sensing electrode further comprises a protection layer disposed on the reference sensing layer.

17. The manufacturing method of the planar dissolved oxygen sensing electrode according to claim 11, wherein at the step (b), the plural catalyst particles and the polymer matrix of the oxygen sensing layer are formed on the first reaction zone by means of an electrophoresis, an electrical polymerization, a droplet coating or a screen printing.

18. The manufacturing method of the planar dissolved oxygen sensing electrode according to claim 11, wherein the step (b) further comprises a step of (b1) forming an insulating and waterproof layer on the electric-conductive layer to cover the second conductive part and partially cover the first conductive part, wherein a portion of the first conductive part is exposed from the insulating and waterproof layer and configured as the first reaction zone.

19. The manufacturing method of the planar dissolved oxygen sensing electrode according to claim 11, wherein the step (c) further comprises a step of (c1) providing a pad including an opening and placing the pad on the at least one planar surface of the insulating base plate, wherein the pad is disposed around the oxygen sensing layer and the referencing sensing layer, and the electrolyte layer is accommodated in an interior of the opening.

20. The manufacturing method of the planar dissolved oxygen sensing electrode according to claim 19, further comprising a step of (d) forming a gas diffusion layer on the electrolyte layer and attaching the gas diffusion layer to the pad, so as to hold the electrolyte layer in the interior of the opening.
